(19) United States
(12) Patent Application Publication
(10) Pub. No.: US 2004/0199469 A1
(43) Pub. Date: Oct. 7, 2004

(54) Biometric transaction system and method

(76) Inventors: Katrina A. Barillova, Beverly Hills, CA (US); Robert Michalko, Beverly Hills, CA (US)

Correspondence Address: CISLO & THOMAS, LLP, 233 WILSHIRE BLVD, SUITE 900, SANTA MONICA, CA, 90401-1211, US

(21) Appl. No.: 10/393,884

(22) Filed: Mar. 21, 2003

(51) Int. Cl. G06F 17/60

(52) U.S. Cl. 705/44; 705/39

(57) ABSTRACT

A method and system for authentication of online commercial transactions between a customer and a merchant using a computer system is provided. According to a preferred embodiment, the method comprises the steps of registering a customer, wherein the customer is given a money tag device by a communication information center (CIC) and the customer registers with the CIC a PIN, at least one registration biometric sample, and at least one customer financial account. The method may also includes a merchant registration step, wherein the merchant registers with the CIC at least one merchant financial account. In a customer identification step, the customer sends personal authentication information comprising a PIN, at least one biometric sample that is obtained from the customer's person, and money tag ID to the CIC.

### BACKGROUND OF THE INVENTION

1. Field of the Invention

This invention relates to the field of biometric electronic payments and financial transactions.

2. Description of the Related Art

Electronic commerce via distributed network environments such as the Internet and intranets has the potential for replacing many forms of traditional commerce. Future growth of online e-commerce transactions promises 1 trillion dollars worth of total revenues by 2010. No financial institution will be left unaffected by the rapid growth of electronic commerce. One obstacle that can inhibit this growth, however, is the lack of secure electronic payments and the threat of fraud. This concern stems in part from the difficulty of providing verification and accountability of both customer and merchant via the Internet.

It is easy for legitimate and illegitimate businesses alike to set up web sites to solicit business over the Internet. Accordingly, customers are wary about purchasing goods or services and sending confidential information such as credit card numbers to Internet based businesses without a degree of certainty as to the authenticity and legitimacy of an Internet merchant. From the merchant side, on the contrary, as verification of customer identity is based solely on data placed on the token (e.g. credit card), that does not have a very strong connection with the individual, the identification of the rightful owner of the token is tenuous at best. Thus, a credit card which may be lost or stolen can easily be used by a person other than the rightful owner.

While theft of a token constitutes the majority of fraud in the system, fraud from counterfeit credit cards is rising rapidly. Counterfeit credit cards are manufactured by a more technically sophisticated criminal who acquires a cardholder's valid account number, produces a valid-looking counterfeit card, encodes the magnetic strip, and embosses the counterfeit plastic card with the account number. The card is then repeatedly presented to merchants until the account's credit limit is reached. Another form of loss is caused by a criminal seller or his employees who obtains the cardholder's account number and enters fictitious transactions against the card and then takes cash out of the till. It is estimated that losses due to all types of fraud exceeds one billion dollars annually.

The financial industry is well aware of the trends in fraud, and is constantly taking steps to improve the security of the card. However, the tenuous linkage between the buyer and his token remains a fundamental reason behind card fraud today.

Identifying humans is hence increasingly becoming a function necessary for establishing a provable relationship between a person and certain information, for use in payment systems. Related technologies are described in Miller, B, “How to Think About Identification”, The 1995 Advanced Card and Identification Technology Sourcebook, pp. 17-27, Warfel and Miller Inc., Rockville, Md., 1995, hereinafter referred to as “Miller”. Miller describes these technologies as those automated methods of identifying a human being based on physiological or behavioral characteristics.

According to Miller all such identification processes can be constrained into a model using a single or a combination of three basic building blocks. A person can be identified by something s/he knows, e.g., a personal identification number (PIN); something a person possesses, e.g., a credit card, and/or something about such a person, e.g. a biometric feature. Various biometrics have been suggested, such as fingerprints, hand prints, voice prints, retinal images, handwriting samples and the like.

Using a token that includes both a biometric and a PIN, as opposed to merely verifying a buyer's possession of any physical objects that can be freely transferred, can greatly reduce stolen and counterfeit card fraud.

In one approach, authenticated biometrics are recorded from a user of known identity and stored for future reference on a token. In every subsequent access attempt, the user is required to physically enter the requested biometric, that is then compared to the authenticated biometric on the token to determine if the two match in order to verify user identity. However, because the biometrics are generally stored in electronic (and thus reproducible) form on a token and because the comparison and verification process is not isolated from the hardware and software directly used by the buyer attempting access, a significant risk of fraud still exists. Examples of this approach to system security are described in U.S. Pat. No. 4,821,118 to Lafreniere; U.S. Pat. No. 4,993,068 to Piosenka et al.; U.S. Pat. No. 4,995,086 to Lilley et al.; U.S. Pat. No. 5,054,089 to Uchida et al.; U.S. Pat. No. 5,095,194 to Barbanell; U.S. Pat. No. 5,109,427 to Yang; U.S. Pat. No. 5,109,428 to Igaki et al.; U.S. Pat. No. 5,144,680 to Kobayashi et al.; U.S. Pat. No. 5,146,102 to Higuchi et al.; U.S. Pat. No. 5,180,901 to Hiramatsu; U.S. Pat. No. 5,210,588 to Lee; U.S. Pat. No. 5,210,797 to Usui et al.; U.S. Pat. No. 5,222,152 to Fishbine et al.; U.S. Pat. No. 5,230,025 to Fishbine et al.; U.S. Pat. No. 5,241,606 to Horie; U.S. Pat. No. 5,265,162 to Bush et al.; U.S. Pat. No. 5,321,242 to Heath, Jr.; U.S. Pat. No. 5,325,442 to Knapp; U.S. Pat. No. 5,351,303 to Willmore, all of which are incorporated herein by reference.

An example of another token-based biometric smartcard system can be found in U.S. Pat. No. 5,280,527 to Gullman et al. In Gullman's system, the user must carry and present a credit card sized token (referred to as a biometric security apparatus) containing a microchip in which is recorded characteristics of the authorized user's voice. In order to initiate the access procedure, the user must insert the token into a terminal such as an ATM, and then speak into the terminal to provide a biometric sample for comparison with an authenticated sample stored in the microchip of the presented token. If a match is found, the remote terminal signals the host computer that the transaction should be permitted, or may prompt the user for an additional code, such as a PIN that is also stored on the token, before authorizing the transaction.

Another example can be found in U.S. Pat. No. 6,325,285 to Baratelli, where the token is an improved smart card comprising a CPU, memory, and a fingerprint reader including a sensing surface. When an individual inserts the smart card into a write/read unit, the smart card creates an electrical representation of the individual's fingerprint and compares the acquired representation to a stored fingerprint representation in the card's memory. If the acquired representation matches the stored representation, the card is enabled, and the user is given access to services that require cooperation of the smart card.

Uniformly, although the above patents reduce the risk of unauthorized access as compared to PIN codes, their use of a token as the repository for the authenticating data greatly diminishes any improvement to fraud resistance resulting from the replacement of a numeric code with a biometric. Moreover, for added security, a token comprising two biometric readers may be employed.

Another approach can be found in a group of patents that relate to a tokenless authentication. In the tokenless authentication the token (e.g. smartcard) is missing and the person is identified by only the PIN and his/her biometric information. Examples of this approach are described in U.S. Pat. No. 5,613,012 to Hoffman et al., U.S. Pat. No. 5,838,812 to Pare Jr. et al., U.S. Pat. No. 5,870,723 to Pare Jr. et al., U.S. Pat. No. 6,154,879 to Pare Jr. et al., U.S. Pat. No. 6,366,682 to Hoffman et. al., all of which are incorporated herein by reference.

In Hoffman's patent the transaction between a buyer and a seller is described in a few steps. At first both buyer and seller are required to register with the computer system, then the buyer sends his/her authentication data through the seller to the data processing center where the authorization is performed and the result is sent to both buyer and seller. As mentioned, the seller is given access to the buyer's personal authentication data with all the possible consequences.

Although the tokenless authentication reduces the risk of unauthorized use of the token, the area of usability is limited to the places where biometric scanner is already built in into an authentication device (e.g. ATM, kiosks). For home or office use the token still serves as the security increasing element and also may be used as the means of obtaining person's biometric data.

The technology of electronic commerce has adopted a number of terms that need to be defined in order to discuss the prior art and the invention. A short glossary of such terms follows.

Acquirer—The financial institution (or an agent of the financial institution) that receives from the merchant the financial data relating to a transaction, authorizes the transaction, obtains the funds from the issuer, and pays those funds into a merchant financial account. The acquiring institution can act as its own merchant certificate authority (MCA) or can contract with a third party for service.

Authentication—In computer security, the process used to verify the identity of a user or the user's eligibility to access an object; verification that a message has not been altered or corrupted; a process used to verify the user of an information system or protected resources.

Authorization—In payment card systems, the process used to verify that a credit or debit account is valid and holds sufficient credit or funds to cover a particular payment. Authorization is performed before goods or services are provided, in order to ensure that the cardholder credit can support payment.

Browser—A computer program that allows a user to read hypertext messages such as HTML pages on the World Wide Web.

Certificate—A document issued by a trusted party that serves as physical evidence of the identity and privileges of the holder. Usually used as synonymous with an electronic certificate or digital certificate since an actual document is of little value in a world of electronic commerce.

Certificate authority (CA)—an organization that issues certificates. The CA responds to the actions of a Registration Authority (RA) and issues new certificates, manages existing certificates, renews existing certificates, and revokes certificates belonging to users who are no to longer authorized to use them.

Certificate chain—a hierarchy of trusted digital certificates that can be “chained” or authenticated back to the “chain's” ultimate trust level—the top of the hierarchy called the “root certificate.”

Digital certificate—An electronic document digitally signed by a trusted party. The digital certificate binds a person's or entity's unique name to a public/private key pair.

Digital signature—Data that is appended to, or is a cryptographic transformation of, a data unit. Digital signature enables the recipient of the data unit to verify the source and integrity of the unit and to recognize potential forgery.

Issuer—a financial institution that issues payment cards to individuals. An issuer can act as its own cardholder certificate authority (CCA) or can contract with a third party for the service.

Key pair—In computer security, a matched set of public and private keys. When used for encryption, the sender uses the public key half to encrypt the message, and the recipient uses the private key half to decrypt the message. When used for signing, the signer uses the private key half to sign a message, and the recipient uses the public key half to verify the signature.

Merchant server—a Web server that offers cataloged shopping services, similar to a physical store, and may include auction type shopping and other methods of transacting purchases over the Web.

Password—For computer or network security, a specific string of characters entered by a user and authenticated by the system in determining the user's privileges, if any, to access and manipulate the data and operations of the system.

Payment card—a credit card or debit card that is issued by a financial institution and shows a relationship between the cardholder and the financial institution.

Registration authority (RA)—An organization or person authorized or licensed to authenticate a certificate requestor's identity and the services that the requester is then authorized to use. The RA approves requests so that certificates can be issued, renewed, updated, or revoked by a CA. The RA is usually a credit officer of an issuing or acquiring bank and approves the certificate requests for its members.

Secure Sockets Layer (SSL)—A security protocol that allows the client to authenticate the server and all data and requests to be encrypted. SSL offers a very limited trust model and a secure link between client and server.

Trusted Root—the base or top level certificate that provides the basis for the trusted hierarchy.

### SUMMARY OF THE INVENTION

The invention provides a method and system for authentication of online commercial transactions between a customer and a merchant using a computer system. The method comprises the steps of registering a customer, wherein the customer is given a money tag device by a communication information center (CIC) and the customer registers with the CIC a PIN, at least one registration biometric sample, and at least one customer financial account.

The method also includes a merchant registration step, wherein the merchant registers with the CIC at least one merchant financial account. In a customer identification step the customer sends personal authentication information comprising a PIN, at least one biometric sample that is obtained from the customer's person and money tag ID to the CIC.

The CIC attempts to look up the authentication information in the registration database for producing either a successful or failed identification of the customer. In the case of successful identification a temporary random private code is generated by the CIC and sent to the customer's money tag. The private code substitutes customer's authentication information (i.e. PIN, biometrics and money tag ID) during the next processing until the transaction is complete in order to avoid transferring authentication information to the merchant and spreading it across the network.

In a proposal step, the merchant offers a proposed commercial transaction to the customer usually comprising price information. If the customer accepts the merchant's proposal, in an acceptance step, the customer's money tag adds to the proposed commercial transaction the private code generated previously by the CIC.

In a transmission step, the transaction data including the private code is transferred from the merchant's server to the CIC for the private code verification. Upon a successful verification, the CIC in a payment step, constructs a transaction draft given the customer and merchant financial accounts, the transaction amount, and the associated transaction information, and forwards the transaction information to an external computer system such as one operated by VISA International, where the authorization and money transfer occurs. In a presentation step, any combination of success or failure of any of the above-mentioned steps is presented to the customer and/or merchant.

The customer being identified is remote from the merchant, and transaction proposals and other information is transmitted from merchant to customer and vice versa using the Internet. All electronic communications to and from the CIC are encrypted using industry standard encryption technology, where each identification station has its own key pair that is known only to that particular station and the CIC.

A commercial transaction is conducted with the customer's money tag connected to the customer's computer that is connected to the Internet.

The CIC may communicate with one or more external computer systems in order to forward transaction information for authorization at the acquirer.

The biometric sample scanned during registration is compared with a collection of biometric samples from customers who have been designated as having previously attempted to perpetrate fraud or who have actually perpetrated fraud upon the system, thus eliminating registration of repeat offenders.

In the unlikely event of the theft of biometric information, the situation can be remedied by simply changing the PIN which belongs to the person's biometric sample. After this is done, the criminal can no longer use the biometric sample to authorize transactions.

The invention is advantageous and superior to existing systems in being highly fraud resistant. As discussed above, present authentication systems are inherently unreliable because they base determination of a user's identity on the physical presentation of a manufactured object (token) along with, in some cases, information that the user knows. Unfortunately, both the token and information can be transferred to another, through loss, theft or by voluntary action of the authorized user. Thus, unless the loss or unintended transfer of these items is realized and reported by the authorized user, anyone possessing such items will be recognized by existing authentication systems as the consumer to whom that token and its corresponding financial accounts are assigned.

By contrast, the present invention virtually eliminates the risk of granting access to unauthorized customers by determining identity from an analysis of a customer's unique characteristics. It is the main object of the invention to provide a commercial transaction system that is capable of verifying a customer's identity based on one or more unique characteristics physically personal to the customer, as opposed to verifying mere possession of proprietary objects and information.

The invention further prevents fraud by storing authentication information and carrying out identity verification operations at a location that is operationally isolated from the customer and/or merchant, thereby preventing the customer and/or merchant from acquiring copies of the authentication information or from tampering with the verification process. Such a system is clearly superior to existing token-based systems wherein the biometric authentication information are stored on and can be recovered from the token, and wherein the actual identity determination is performed at the same location as the customer during the authentication process.

### OBJECTS OF THE INVENTION

It is an object of the present invention is to provide a commercial transaction system that is practical, convenient, and easy to use.

Still another object of the invention is to provide a commercial transaction system that is highly resistant to fraudulent access attempts by non-authorized users.

Still another object of the invention is to authenticate the system to the customer once the commercial transaction is complete, so the customer can detect any attempt by criminals to steal their authentication information.

These and other objects and advantages of the present invention will be apparent from a review of the following specification and accompanying drawings.

### BRIEF DESCRIPTION OF THE DRAWINGS

FIG. 1 is a diagram of the system of the present invention, in accordance with a preferred embodiment.

FIG. 2 is a diagram of the communication information center (CIC) and its internal databases and execution modules, in accordance with a preferred embodiment of the present invention.

FIG. 3 is a diagram of the customer's computer and money tag.

FIGS. 4A and B show a flow diagram illustrating a transaction process, in accordance with a preferred embodiment of the present invention.

### BRIEF DESCRIPTION OF THE APPENDICES

The following appendices are incorporated herein by this reference thereto.

Appendix 1 is a document entitled “Preferred System Architecture” which describes an architecture for the system of the present invention, in accordance with one embodiment.

### DESCRIPTION OF THE PREFERRED EMBODIMENTS

The detailed description set forth below is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The objective of this invention is to provide a secure, reliable, safe, and consistent, method for identifying customers for the purpose of authorizing financial transactions. The system is inherently secure, such that customers' records and biometric information remain confidential and safe, both within the computer system that authenticates the customer, as well as during collection and transfer of authentication information between the computer system and the remote sites with which the computer system communicates.

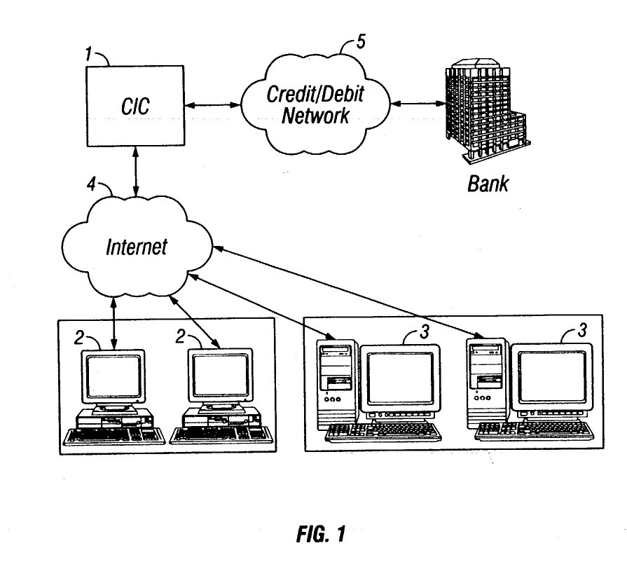

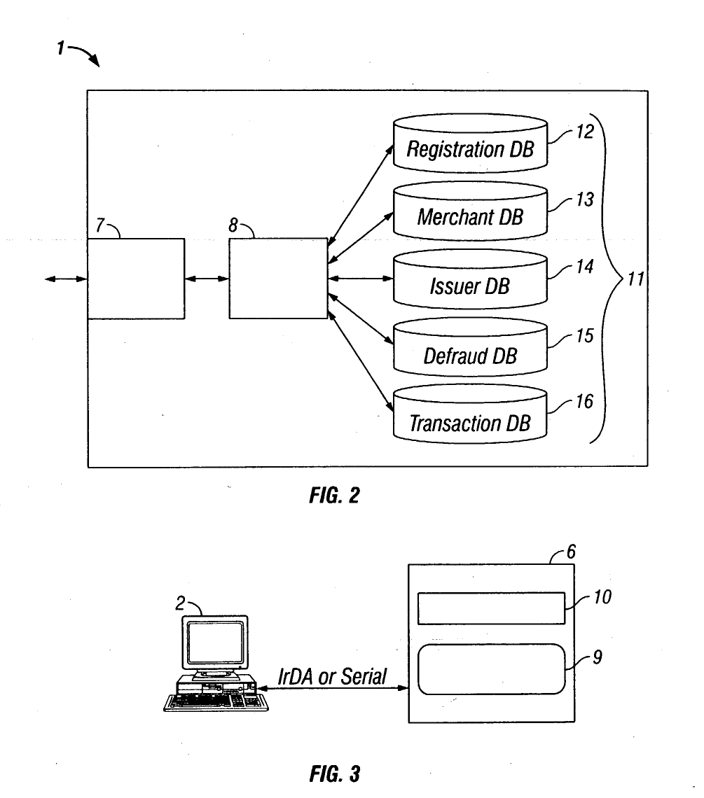

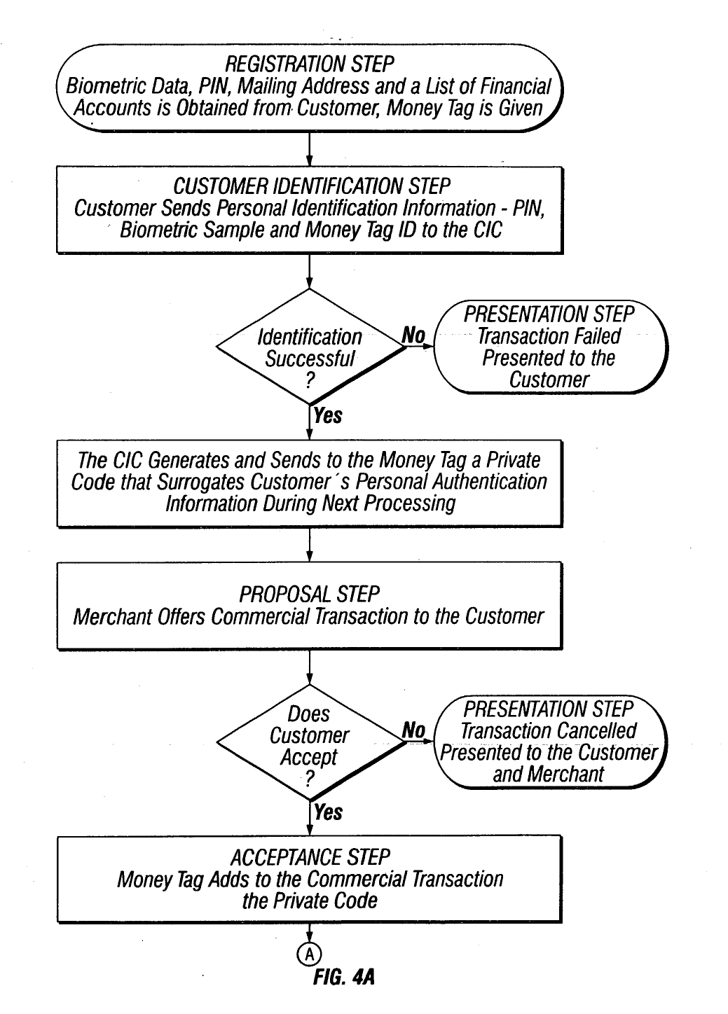

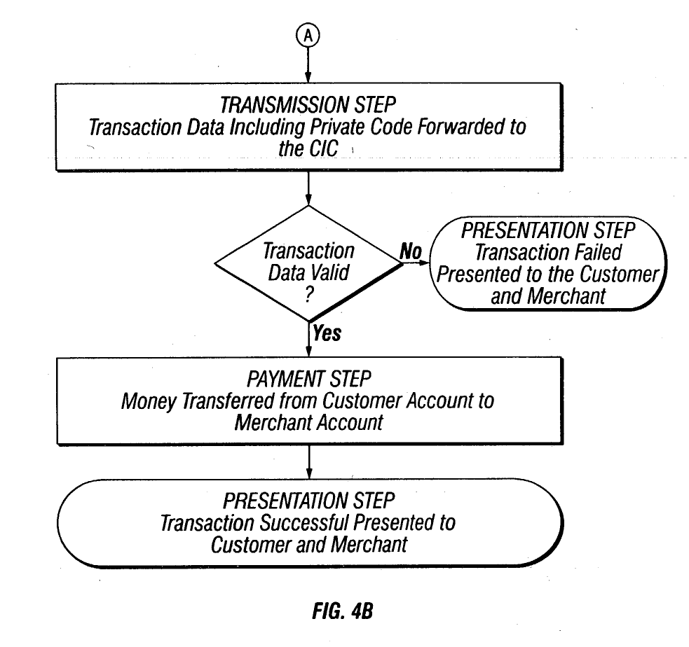

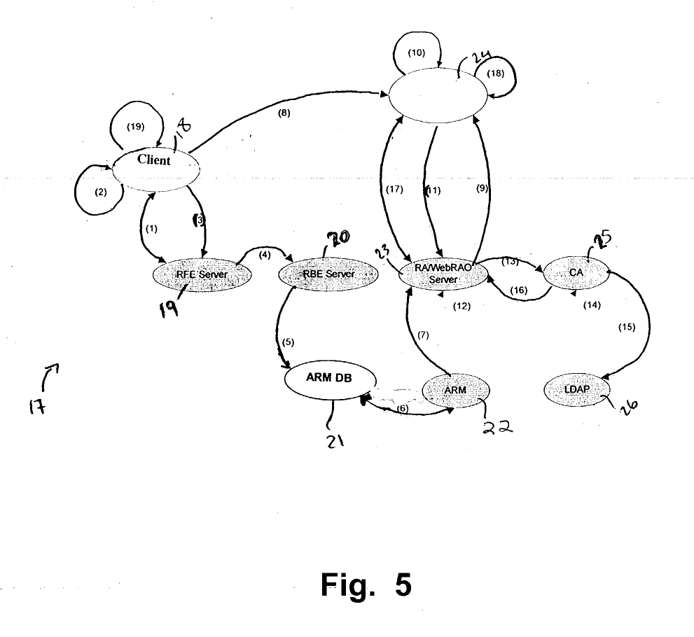

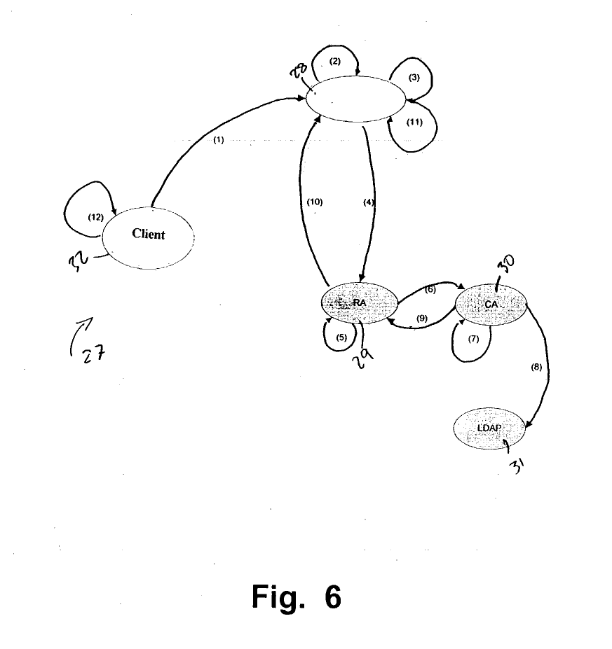

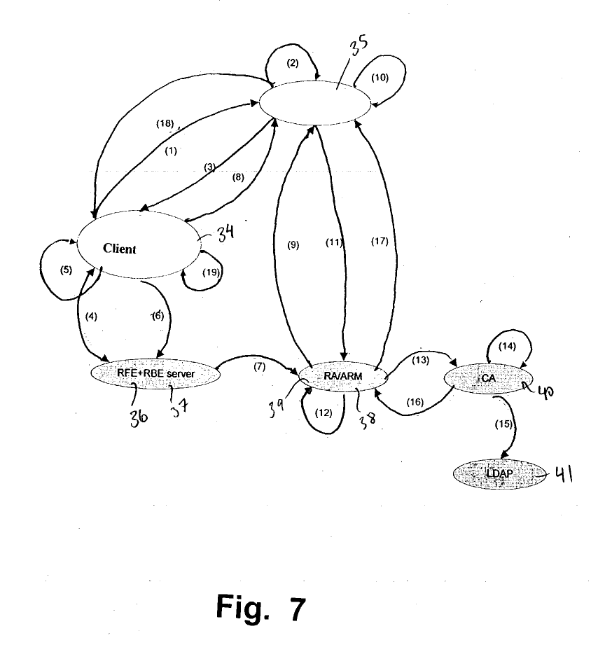

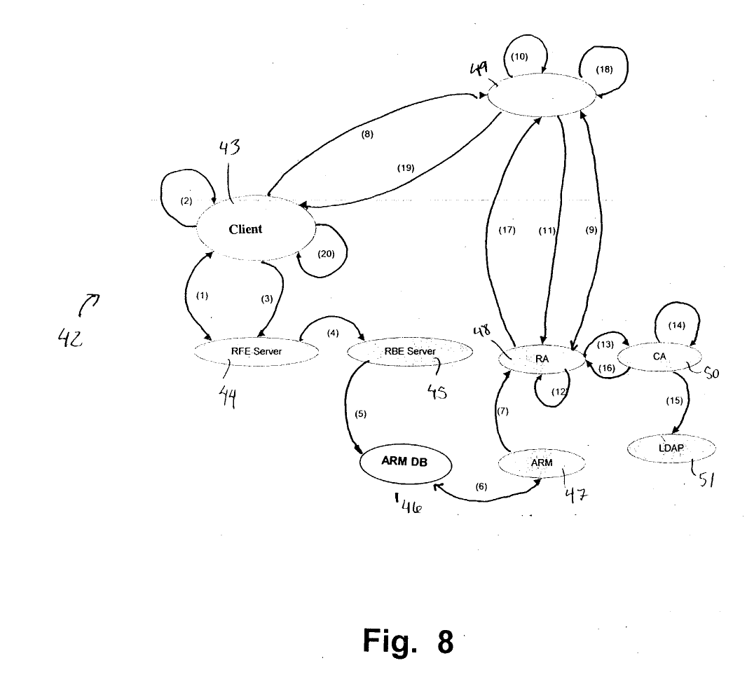

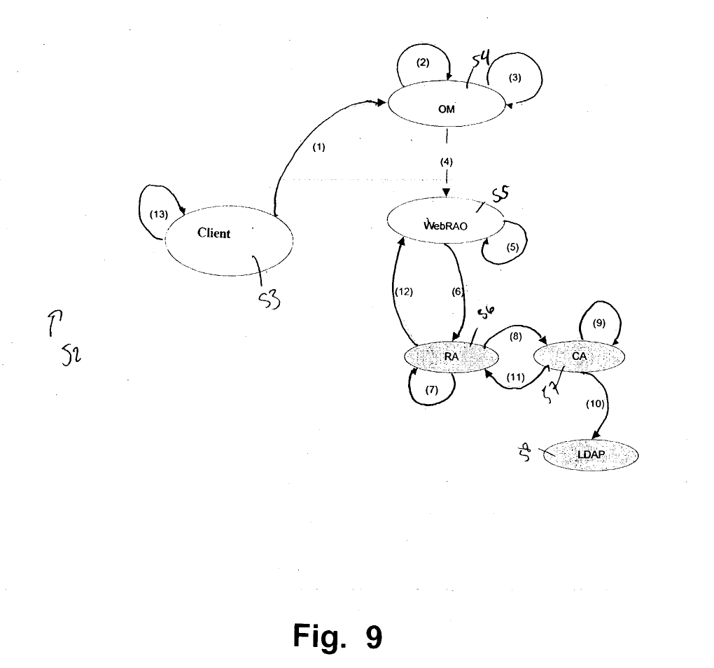

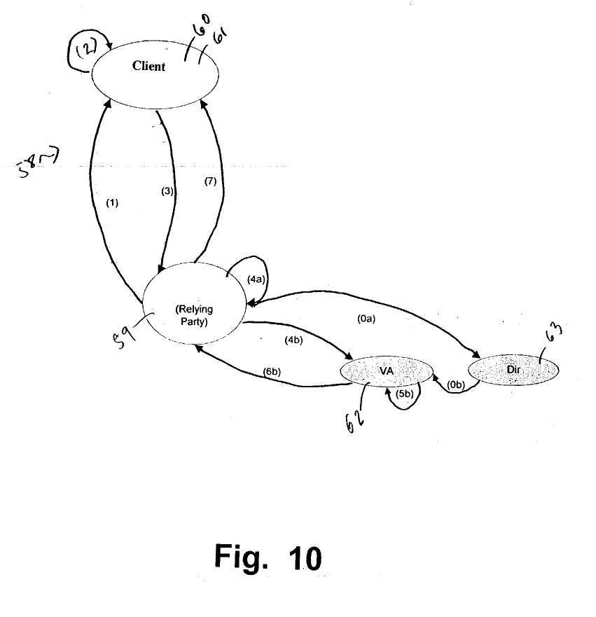

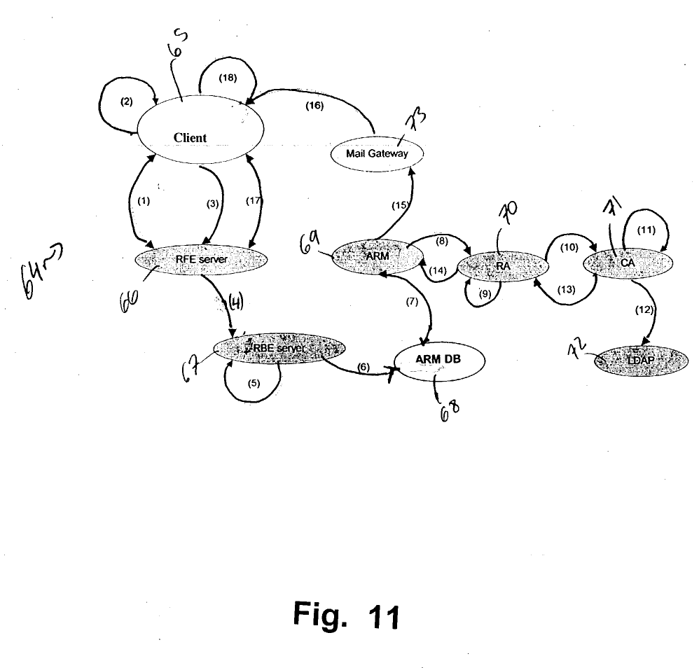

Turning now to the figures, the overall configuration of the invention and its components are shown in FIG. 1, in accordance with a preferred embodiment. Essentially a central unit or Communication Information Center (CIC) 1 is connected to the customer computer(s) 2 and to the merchant server(s) 3 through the Internet 4. The CIC is also connected to and communicates with independent computer networks 5, such as credit/debit networks. The CIC 1 contains several databases and software execution modules as shown in FIG. 2. A Firewall Computer 7 is responsible for prevention of electronic intrusion of the system while a Gateway Computer 8 is responsible for routing all requests from the user, including adding, deleting and otherwise modifying all databases. The Gateway Computer 8 is also responsible for decryption and de-packaging of data that has arrived from the customer and other computers. As shown in FIG. 3, the customer's computer 2 interfaces with the money tag 6, which has a biometric scanner 9 and a display 10. The biometric scanner 9 comprises at least one biometric input element such as a fingerprint scanner or voice input device (microphone). The money tag is further equipped with computing modules, device drivers, and erasable and non-erasable memory modules. The money tag communicates with the customer's computer through an IrDA or serial port. The customer's computer 2 communicates with the CIC 1 and with the merchant's server 3 through the Internet 4. The merchant's server 3 also communicates with the customer's computer 2 and with the CIC 1 through the Internet 4. FIG. 4 shows the steps taken to process a commercial transaction, according to a preferred embodiment, from registration through presentation of results.

The components and the method of the invention are described in detail as follows.

1. Money tag

The money tag 6 is a combination of hardware and software whose job is to scan and encrypt customer biometric data for use in commercial transaction, to receive a PIN from the customer's computer, to send encrypted authentication information (i.e. PIN, biometric data and money tag ID) through the customer's computer to the CIC 1, to receive an encrypted private code from the CIC 1, and to provide the private code in encrypted form to a computer. It should be noted that a password or alphanumeric combination may also be used instead of a PIN.

The public key cryptography is preferably used for encryption of the authentication information and private code during transfer from the CIC 1 to the money tag 6 and also from the money tag 6 to the CIC 1. The money tag 6 is a physically separate device from the customer's computer. The computer communicates with the money tag 6 by sending commands and receiving results over the serial port or standard infrared IrDA port.

Preferably, the money tag's external interface is strictly limited and the construction of the money tag 6 makes it extremely difficult to tamper with the contents. Each money tag 6 has its unique encryption key pair, known only to the money tag 6 and the CIC 1, and a hardware identification code previously registered with the CIC 1. The money tag 6 is only allowed to perform operations limited to its designated function.

The money tag 6 is constructed with the assumption that the controlling computer can be a source for fraud, so that the money tag 6 never reveals unencrypted biometric data and the unencrypted private code to the controlling computer. The money tag 6 shows only information messages to the customer on its display 10.

The money tag 6 is a multichip module combined with a fingerprint scanner, a speaker/microphone, or other biometric inpute element, a display, a serial port and/or an IrDA port encased in a hard tamper-resistant case that makes attempts to penetrate obvious. The critical components such as processors, memories, fingerprint scanner and A/D converter are amalgamated into a multichip module (a process for encapsulating several processors in one physical shell, well known in the industry), constructed to protect the communications pathways between the devices from easy wiretapping.

The money tag's memory is preferably divided into groups so that it is hard to reverse engineer critical data. Only the noncritical commonly available code such as embedded operating system, device drivers and encryption library is stored in mask ROM. The mask ROM is cheaper than other types of read only memory, but it is easily reverse engineered, and is not electronically erasable.

The more critical information and software packages such as biometric encoding algorithm, random number generator, command functions, the unique encryption key pair and the hardware identification code are stored in flash ROM. Flash ROM is more expensive, but it is much more difficult to reverse engineer, and most importantly, it is electronically erasable.

The use of Flash ROM makes it more difficult to duplicate a customer's money tag. Only noncritical data such as setup constants are stored in the EEPROM. EEPROM can be erased many times, but is also nonvolatile—its contents remain valid across power interruptions. The most critical data such as PIN, private code and biometric data are stored in RAM. RAM is temporary in nature, and its contents are lost whenever power is lost.

The critical software and data may only be downloaded once into the device, at the time of manufacture. All registers and variables are explicitly cleared when a transaction is canceled or completed. The software does not keep copies of registers in stack variables.

The money tag's enclosure is designed so that upon detecting any opening of the enclosure, the money tag 6 performs an emergency electronic zero of all data residing in flash ROM, EEPROM and RAM followed by all of the software libraries.

2. Customer's Computer

The purpose of this computer is to provide the customer with the ability to purchase products from a remote merchant's web server, to control the money tag 6 and to provide the customer with the ability to authenticate through the CIC 1 via the Internet 4.

The customer's computer may be a standard personal computer with an available Internet connection, HTTP and HTTPS network ports, and a serial or infrared port. The computer should be capable of running ordinary web browser software with ActiveX controls and/or Java enablement.

3. The Communication Information Center (CIC)

The CIC handles financial commercial transactions and customer registration as its main responsibilities.

The CIC 1 may be made up of a number of computers and databases 11 connected together over a Local Area Network (LAN) as illustrated in FIG. 2. The CIC 1 preferably has electrical power backup and multiple redundancy in all of its critical hardware and database systems.

The entry point of the CIC 1 is preferably a Firewall computer 7. It provides a first line of defense against network viruses and computer hackers. All communication links into or out of the CIC 1 first pass through this computer. The firewall also disallows any undesirable transmissions from the internal network to the rest of the Internet.

The CIC system coordinator and request processor is a gateway computer 8. It links the outside world (money tag equipped customer computers and other computers) to the internal components of the CIC 1, supervises the processing of each received request, communicates with the various CIC components as necessary, and sends the encrypted reply back to the sender. All received requests and any warnings from the CIC components are logged.

The CIC 1 may comprise several databases, each fulfilling a specific purpose. These include: a Registration database 12 which has a list of valid customers with each customer's biometric data, PIN code, money tag ID, and financial account(s); a Merchant Database 13 which has information about merchants necessary to process transactions, such as the merchant financial account information; an Issuer Database 14 which identifies issuing banks that participate with the system; a Defrauders Database 15 which has a list of known system defrauders; and a Transaction Database 16 which records all transactions.

The customer's and merchant's computers accomplish their tasks by sending requests to the CIC site. The CIC site sends back a reply containing the status on the success or failure of the operation.

If a customer is found to have defrauded the system, the CIC 1 may institute a biometric database search for the customer. These searches are preferably performed each night during conditions of light activity. Such search may reveal potential inconsistencies, such as significantly different credit card use patterns by a specific customer, which may indicate credit card fraud.

4. Preferred Method Steps

In a registration step, personal information from new customers is obtained which may include the customer's biometric data, PIN or other information known to the user, mailing address and at least one financial account.

The registration institution may use its standard customer identification procedure (signature cards, employee records, personal information, etc.) before registering the customer on the system. It is important for the institution to thoroughly verify customer identity, since the registered customer will be empowered to make purchases and transfer money from those financial accounts at will.

During registration, the customer selects a PIN and enters at least one registration biometric sample, such as index finger prints or next innermost finger prints if the customer is missing index fingers, or a voice sample such as a password phrase spoken into a recording machine. Requiring specific fingers to be used (such as the index finger) allows the prior fraud check to work. The registration biometric samples are then stored into the CIC database.

If a financial account number is registered without the participation of the issuing institution, the financial account owner may be required to sign an agreement at the time of registration authorizing the release of funds whenever a properly authorized transaction is received by the system. Confirmation of identity should preferably be required to validate the signature, either through a telephone contact or an in-person examination of the registrant's identity documents.

The ability to authenticate transactions will only be enabled once the registration is confirmed. The customer is also issued a money tag device upon registration.

In an authentication step, the customer must be authenticated by the CIC 1 in order to obtain the temporary private code for the transaction. The customer's computer connects to the CIC web server using the Internet, and downloads and installs software such as Java or ActiveX control that enables communication with the money tag 6 from web browser. This operation is required to be performed only once, upon the customer's first connection with the CIC. Once a connection is established and Java or ActiveX control is present on the customer's computer, the unsecured HTTP connection is changed to a secure HTTPS using SSL protocol, wherein the customer's computer secures the Internet connection by generating and then sending a Session Key to the CIC 1. In order to assure that the session key is protected from disclosure, it is encrypted with the CIC's Public Key using Public Key Encryption. When the CIC 1 receives this encrypted Session Key, it decrypts it using its Private Key. Then both computers announce that future communication will be encrypted with the Session Key and that the Session Key is no longer being transferred. This process is called securing a connection through a Public Key Encrypted secret key exchange. Once securely connected the identification web page is displayed on the customer's computer, where the customer is asked to enter the PIN through the computer keyboard and the money tag 6 is instructed to scan customer's biometric data.

The PIN is sent from the computer to the money tag 6. Once the money tag 6 obtains the PIN and biometric data, it sends authentication information (i.e. PIN, biometric data and money tag ID) in encrypted form to the customer's computer. Upon receiving encrypted authentication information, the computer forwards it as a request to the CIC web server. The CIC 1 decrypts the authentication information and looks up the registration database for producing either a successful or failed identification of the customer. In the case of successful identification a temporary random private code is generated by the CIC 1 and sent in encrypted form as a reply to the customer's computer. The customer's computer then forwards the encrypted private code to the money tag 6. The money tag 6 decrypts the private code and stores it into RAM.

In a proposal step, the customer connects to the merchant's web server using the Internet and the merchant's offer, typically comprising price information, is displayed to the customer.

If the customer accepts the merchant's proposal, in an acceptance step, the unsecured HTTP connection is changed to secure HTTPS using SSL protocol in the above described way (this time the Session key is sent to merchant's server not the CIC) and the customer's computer sends to the money tag 6 the merchant's identification code, and transaction information which may comprise product information and price. Other items of transaction information may be included, such as a list of goods and/or services, a merchant name, a date and time, a location, or an invoice number.

The money tag 6 then adds to the received commercial transaction data the private code generated previously by the CIC 1, encrypts the transaction data including the private code, and sends such encrypted transaction information to the customer's computer. Upon receiving the encrypted transaction information, the computer forwards it as a request to the merchant's web server.

The merchant's server is connected to the CIC via the same sort of secure connection that the customer's computer has with the CIC. Upon receiving encrypted transaction information from customer's computer, the merchant's server, in a transmission step, forwards the transaction information to the CIC 1 for validation. The merchant's server secures the connection to the CIC using the session key.

In a payment step the CIC 1 decrypts the transaction information, validates the private code, cross-checks the merchant identification code contained in the request with the merchant identification code stored under the hostname that was sent in the request, then constructs a transaction draft given the customer and merchant financial accounts and the associated transaction information, and forwards the transaction to a credit/debit network where the authorization and money transfer occurs.

Once the credit/debit network responds, in a presentation step, the CIC 1 constructs a response message including the credit/debit authorization and address of the customer, and sends that message back to the merchant's server. Once the merchant's server receives the response, it copies the customer's address out of the response and forwards the response message to the customer's computer. The customer's computer browser shows the result of the transaction, be it success or failure.

Since the system in general assumes that an adversary inhabiting the network can hijack network connections at any point, all parties must have secure communications during their real-time interactions. The main concern is not disclosure of information, but rather insertion or redirection of messages.

The whole system of Public Key Encryption relies on having a trusted source for the Public Keys. These trusted sources are called Certifying Authorities (CA), one of which is the company VeriSign, Inc.

Use Cases

The following provides practical examples of how the system of the present invention may be implemented. Also, these examples could be a guide for the designed solution completeness check.

1. Registration Processes for Bank Clients

Registration processes for external users of the system of the present invention (e.g. bank clients) are described below. Possible registration scenarios include the following:

a) Client's personal visit to a branch office:

to i. a distant registration process for external clients with software certificates

ii. a face-to-face registration process for external clients with software certificates

iii. a face-to-face registration process for external clients with Biometric Credit Card certificates

iv. a distant registration process for external clients with Biometric Credit Card certificates

b) Client's personal visit to an unattached business place:

i. personal registration process for external clients with software certificates

ii. distant registration for external clients with software certificates

iii. personal registration process for external clients with certificates

iv. distant registration process for external clients with certificates

The final step of each registration process will be a validation process initiated by a client. The purpose of the validation process is for verification of an issued certificate. The validation process begins after receipt of the installed certificate. The validation process (described below) may be the same for different types of registration processes.

1.1 Distant Registration Process for External Clients with Software Certificates

This process fills in a demand for a certificate and generates keys in the client's PC. Thereafter, a form is transferred to the biometric credit card via Internet.

The Bank's registration operator may approve the demand for a certificate upon the client's personal visit to the bank wherein the operator verifies the client's identity. The client may also be required to sign an agreement regarding the banks certificate granting policies.

A special application (or part of an application) will provide the distant registration process for both the client and the biometric credit card.

The Application generates a data message containing a demand for a certificate in PKCS#10 format. The demand for a certificate will be transferred by an application to the Registration FrontEnd (RFE) Server that will transfer the data to the Registration BackEnd (RBE) Server where the data from the demand will be preprocessed and sent to the Advanced Registration Module (ARM) database. ARM will provide further processing of data and will resend data for further processing to the Registration Authority (RA).

FIG. 4 is a flow chart 17 illustrating the registration process of external clients with software certificates, according to one embodiment. The steps for this process, numbered (1) through (19) in the figure, are as follows:

(1) The Bank's client 18 activates Java application for a distant registration process at home. The client may download the application from a bank's freely accessible web page (RFE Server 19).

(2) The client fills in an electronic registration form (including revocation password and password for accessing keys' storage) and generates keys. Keys are saved on a floppy disk or hard disc. Applet generates a “fingerprint” that will be used in a process of personal verification of the client's identity at a registration place, and writes it on the screen so the client can copy it. Thereafter the “fingerprint” may be printed and saved to a file, say “demands.txt,” which may include other client data. When identifying the client (during client's personal visit of the bank), the client will have to produce the demands.txt file in printed or in electronic form, or fingerprints copied from the screen. (The last alternative is least preferred due to possible error in copying).

(3) The application completes the demand for the certificate and transfers it to the RFE server 19.

(4) The RFE server 19 resends the demand for the certificate to RBE Server 20.

(5) The RBE formats the demand for the certificate to an appropriate format for ARM and saves the data to the ARM database 21.

(6) The ARM takes over the data from the ARM database 21 wherein the data is processed.

(7) The ARM will resend the output from the processed data to the RA (or to RA database 23).

(8) The client personally visits the branch office 24.

(9) A registration operator obtains the demand for the software certificate from the RA database 23.

(10) The registration operator verifies the client's identity and fingerprint generated with the client and compares them with the data saved in the demand. The client signs an agreement concerning granting certificates.

(11) The registration operation submits the processing of the demand for certificate to the RA.

(12) The RA automatically signs the demand.

(13) The RA sends the signed demand to the certificate authority (CA) 25.

(14) The CA 25 issues a new certificate signed by a private CA key.

(15) The CA 25 publishes the newly issued certificate in an LDAP directory 26.

(16) The CA 25 sends the newly issued certificate to the RA 23.

(17) The registration operator picks up the newly issued certificate.

(18) The registration operator exports the certificate to a floppy disk and hands it over to the client. The certificate may also be distributed via e-mail, if the client so requests.

(19) The client installs the new certificate to his keys storage.

1.2 Personal Registration Process for External Clients with Software Certificates

The basic principle of a face-to-face registration process with software certificates is generation of keys and a demand for the software certificate at a bank's registration place. A client personally visits the bank's registration place, and produces the necessary information for issuing the demand to the registration operator. The registration operator verifies the client's identity and the client signs the agreement regarding issuing certificates. The registration operator generates the demand for the certificate based on the information from the client. The registration operator further generates the keys, saves them on a floppy disk, and hands them to the client.

FIG. 6 is a flow chart 27 illustrating the steps for the above described face-to-face registration process for external clients with software certificates, wherein the steps are numbered (1) through (12) in the figure. The steps of the process are as follows:

(1) The client visits the bank's registration place 28.

(2) The client fills in a paper form with a demand for a certificate, and signs the agreement with the bank.

(3) A registration operator fills in the electronic form with the demand for a certificate based on the form filled in by the client. The registration operator also generates the keys in his computer and saves them on a floppy disk assigned for the client.

(4) The registration operator submits the processing of the demand for the certificate to the RA 29.

(5) The RA 29 automatically signs the demand.

(6) The RA 29 sends the signed demand to the CA 30.

(7) The CA 30 issues a new certificate signed by a private CA key.

(8) The CA 30 publishes the new certificate in an LDAP directory 31.

(9) The CA 30 sends the newly issued certificate to the RA.

(10) The registration operator picks up the newly issued certificate.

(11) The registration operator exports the certificate to a floppy disk and hands it to the client 32. The certificate may also be sent via e-mail, if the client so requests.

(12) The client 32 installs the newly issued certificate to his keys storage.

Steps 2 and 3 of this procedure may be altered wherein the registration operator fills in the electronic demand for the certificate based on an ID (e.g. passport) and an e-mail address, which may be offered to clients in a paper form, for exactness. This demand will be printed and consequently signed by the client.

1.3 Face-to-Face Registration Process for External Clients with BCC Certificates

This process is similar to the previous process of face-to-face registration with software certificates. This process assumes that the client does not dispose of the safety object or BCC.

A preferred registration process enables the client to visit the bank's registration place only once, in which visit the bank will settle all necessary matters concerning issuing of an electronic certificate on the BCC, including handing in the demand for a certificate, signing the agreement regarding granting electronic certificates, verification of data in the demand, issuing a BCC and installing the certificate. Demand for the certificate and the generation of keys on the BCC is ensured by the registration operator on the assigned computer and in the bank's registration place. After issuing the certificate, the registration operator installs the certificate on the BCC of the customer (the certificate will also be distributed electronically by sending a notification with a web link to the certificate). The whole process will be completed during the same visit.

This process is similar to the “face-to-face” registration process for external clients with software certificates. The steps of this process comprise:

(1) The client visits the bank's registration place.

(2) The client fills in the form with the demand for a certificate and a BCC, and signs the agreement with the bank.

(3) A registration operator fills in the electronic form with the demand for a certificate based on the form signed by the client. The registration operator also generates the keys on client's BCC.

(4) The registration operator submits the processing of the demand for the certificate to the RA.

(5) The RA automatically signs the demand.

(6) The RA sends the signed demand to the CA.

(7) The CA issues a new certificate signed by a private CA key.

(8) The CA publishes the new certificate in an LDAP directory.

(9) The CA sends the newly issued certificate to the RA.

(10) The registration operator picks up the newly issued certificate.

(11) The registration operator installs the certificate on the BCC and hands it to the client (the certificate may also be distributed electronically by an e-mail). The client receives the BCC with keys, certificate, and a standard PIN. The client is provided with detailed instructions on how to change the PIN, which is most preferably changed on the client's own computer.

(12) The client installs the newly issued certificate from the BCC to the system.

Steps 2 and 3 of this procedure can be modified without, wherein the registration operator fills in the electronic demand for the certificate based on an ID (e.g. passport) and an e-mail address (preferably offered to clients in a paper form, for exactness). This demand will be printed and consequently signed by the client.

1.4 Distant Registration Process for External Clients with BCC Certificates

A client that wishes to demand a certificate on a BCC with a medium level of security would be required to have the BCC available at the time of generating the demand for the certificate. Also, based on the BCC request, he may be required to come to the registration place to verify his identity and sign the agreement. The visit to the registration place is meaningful only if the client has already demanded a certificate (distantly). Based on these conditions, possible alternatives for a distant registration process with Certificates include the following:

a) The Client visits the bank's registration place twice:

During his first visit the client asks for and receives a BCC. Then, at home, the client generates a demand for a certificate and keys for a BCC (with the help of a special application that sends the demand via the Internet to the Registration FrontEnd Server). During the client's second visit, a registration operator verifies the client's identity, checks the contents of the demand for the certificate, and the client signs an agreement regarding certificates. After this step, the registration operator shifts the certificate demand for further processing to the RA.

b) The registration process does not include distribution of the BCC and the client visits the bank's registration place only once:

In this case, the registration process will assume that the client has received a BCC by another method from the bank. The client receives a pure initialized BCC. Consequently, he generates the demand for the certificate and keys for the BCC at home (with the help of a special application that sends the demand via the Internet to the Registration FrontEnd Server). The client visits the bank's registration place where his identity is verified, and signs the agreement regarding certificates. The registration operator than shifts the certificate demand for further processing to the RA.

FIG. 7 is a flow chart 33 illustrating the steps for the first procedure, wherein the client visits the bank's registration place twice. The procedural steps, numbered (1) through (19) in the figure, are as follows:

(1) The client 34 visits the bank's registration place 35 for the first time for the purpose of receiving a BCC.

(2) The client 34 signs the demand for the BCC and the registration operator fills the demand.

(3) The client 34 goes home with the BCC (the BCC is “pure,” initialized with a standard PIN).

(4) The client 34 runs Java application from his home for the distant registration process. The application can be downloaded from bank's freely accessible web page.

(5) The client fills in the electronic registration form (including revocational password) and generates keys for the BCC. Applet generates a “fingerprint” to be used in the personal verification of the client's identity at a registration place. It writes the “fingerprint” on the screen for the client to copy, permits the fingerprint to be printed, and saves it to a file, (say “demands.txt”) which includes other data about the client. When identifying the client during client's personal visit to the bank, the client will have to produce the demands.txt file in printed or in electronic form, or fingerprint copied from the screen. (The last alternative is not recommended because of the likelihood of error in copying the fingerprint from the screen)

(6) Applet completes the demand for the certificate to PKCS#7 format and sends it to the RFE Server 36. The RFE Server 36 and RBE Server 37 logically form one Registration Server.

(7) The RBE processes the demand and sends it to the ARM database 38. The ARM loads the data from the database, processes the data and sends the processing output to the RA (or RA database 39).

(8) The client visits the bank's registration place for the second time (with the purpose of confirming identity and checking the demand for the certificate).

(9) The registration operator acquires the demand for the SC from the RA database 39.

(10) The registration operator verifies the client's identity and fingerprints generated for the client, the client signs the agreement regarding granting certificates.

(11) The registration operator submits the processing for the certificate demand to the RA 39.

(12) The RA 39 automatically signs the demand.

(13) The RA 39 sends the signed demand to the CA 40.

(14) The CA issues a new certificate signed by a private CA key.

(15) The CA publishes the newly issued certificate in the LDAP directory 41.

(16) The CA sends the newly issued certificate to the RA.

(17) The registration operator picks up the newly issued certificate and exports it to a floppy disk. The certificate may also be sent by e-mail depending on the client's request.

(18) The client leaves the bank with a floppy disk, wherein the newly issued certificate is saved.

(19) The client installs the new certificate on the BCC.

FIG. 8 is a flow chart 42 illustrating the steps for the second procedure, wherein the registration process does not include distribution of the BCC and the client visits the bank's registration place only once. This alternative is similar to the distant registration process for software certificates. The difference between the two processes is that the client generates keys on the BCC and consequently installs the certificate on the BCC. The procedural steps, numbered (1) through (20) in the figure, are as follows:

(1) The client 43 executes the Java application for a distant registration process at home. The client can download the application from the bank's freely accessible web page.

(2) The client fills in the electronic registration form (including the revocational password), and generates keys on BCC. Applet generates a “fingerprint” that will be used in the personal verification process of the client's identity at the registration place. The applet writes the “fingerprint on the screen for the client to copy, allows him to print it, and saves it to a file (say “demand.txt”), which may include additional data regarding the client. When identifying the client during client's personal visit to the bank, the client will be required to produce the demend.txt file in printed or electronic form, or the copied fingerprint (the last alternative is not recommended because of possible error in copying the fingerprint).

(3) The application completes the-demand for the certificate and sends it to the RFE server 44.

(4) RFE Server resends the demand to RBE Server 45.

(5) The RBE formats the demand for the certificate to the format useful for the ARM and saves the data to the ARM database 46.

(6) The ARM 47 takes over the data from the ARM database and processes the data.

(7) The ARM resends the output from the data processing to The RA (or RA database 48).

(8) The client personally visits the branch office 49.

(9) An employee of the branch office 49 receives the sent demand for the certificate from the RA 48.

(10) The registration operator verifies the client's identity and fingerprint generated for the client, and compares them with the data saved in the demand. The client signs the agreement regarding granting certificates.

(11) The registration operator submits the processing of the certificate demand to the RA 48.

(12) The RA 48 automatically signs the demand.

(13) The RA 48 sends the signed demand to the CA 50.

(14) The CA 50 issues a new certificate signed by a private CA key.

(15) The CA publishes a new certificate in the LDAP directory 51.

(16) The CA sends the newly issued certificate to the RA.

(17) The registration operator picks up the newly issued certificate.

(18) The registration operator exports the certificate to a floppy disk. The certificate may also be distributed via e-mail depending on the client's request.

(19) The client leaves the bank with a floppy disk, wherein the newly issued certificate is saved.

(20) The client installs the newly issued certificate on BCC.

1.5 Distant Offline Registration Process

The bank may be requested to prepare a process of registration for external clients where the registration place may not be connected the BCC net (offline OM, connection failure). Possible alternatives with this process for generating keys include: a) the client generates software keys at home; and b) the client generates SC keys at home. The general steps for this process include:

(1) The client executes Java application for a distant registration process from home. The client can download the application from the bank's freely accessible web page.

(2) The client fills in the electronic registration form (including the revocational password), and generates keys. Applet generates a “fingerprint” that will be used in the personal verification process of the client's identity at the registration place. The applet writes the fingerprint on the screen for the client to copy, allows him to print it, and saves it to a file called demand.txt (with additional data about the client).

(3) When identifying the client during the client's personal visit to the bank, the client will be required to produce the demend.txt file in printed or electronic form, or copied fingerprint.

(4) The application completes the demand for the certificate and sends it to the RFE Server.

(5) The RFE Server resends the demand to the RBE Server.

(6) The RBE formats the demand for the certificate to the format useful for ARM and saves the data to the ARM database.

(7) The ARM takes over the data from the ARM database and processes the data.

(8) The ARM resends the output from the data processing to the RA (or do RA database).

(9) The client personally visits the OM where he fills in the demand in the paper form (since an electronic form is not available). This form also contains information that creates a clear interface between the client's identity and the demand sent electronically (fingerprint).

(10) An employee of the OM verifies the client's identity and compares the information with the data in the demand.

(11) The OM employee submits the processing of the certificate demand to the branch office where WebRAO processes it.

(12) An employee of the branch office (WebRAO) receives the demand for the certificate sent from the RA and compares it with the information in the paper form (which includes the client's identity and fingerprint).

(13) The employee of the branch office (WebRAO) submits the processing of the demand for the certificate to the RA.

(14) The RA signs the demand.

(15) The RA sends the signed demand to the CA.

(16) The CA issues a new certificate signed by a private CA key.

(17) The CA publishes a new certificate in the LDAP directory.

(18) The CA sends the newly issued certificate to the RA.

(19) The registration operator picks up the newly issued certificate and its distribution by e-mail is automatically provided.

(20) The client installs the newly issued certificate to keys storage.

1.6 Personal Offline Registration Process

Possible alternatives with this process, wherein the keys are generated by the bank, include: a) the registration operator generates software keys in the bank; and b) the registration operator generates SC keys in the bank.

A special application for the process at an offline OM may be installed in the registration operator's PC. The client fills in a paper form at the OM. A registration operator fills in the demand for the certificate based on the information from the form. First, the operator verifies the information in the form, then generates keys on a floppy disk or BCC. The demand for the certificate is entered to a file in PKCS#10 format. The registration application provides these activities for the offline OM. It is also possible to modify the registration process so that the client only presents his e-mail address and an ID (passport). The demand for the certificate filled in by the registration operator is printed and signed by the client.

Files with the demands for the certificates and paper forms will be regularly sent to the relevant OM that is connected to the BCC network. The registration operator of the branch office imports the demands for the certificate in PKCS#10 format, checks them and verifies their contents with the information in the relevant paper form. If the content of a paper form does not collide with the electronic form, the certificate is shifted to further processing. Further steps for processing of the certificate demand and distribution of a new certificate are similar to those in the other registration processes. FIG. 9 is a flow chart 52 illustrating the offline registration process wherein the keys are generated by the bank. The procedural steps, numbered (1) through (13) in the figure, are as follows:

(1) The client 53 personally visits the bank's working place (working in offline mode) and fills in a paper form with the demand for a certificate.

(2) The employee of the OM 54 verifies the client's identity and compares it with the information in the demand.

(3) The OM employee ensures the filling in of the certificate demand and generating of keys (Software or SC). The certificate demand is formatted to a file in PKCS#10 format and saved in the OM.

(4) The employee of the OM shifts the processing of the demand to a branch office where WebRAO 55 processes it.

(5) The employee of the branch office (WebRAO) receives the demand for the certificate sent by the RA 56 and compares it with the information in the paper form.

(6) The employee of the branch office (WebRAO) submits the processing of the demand to the RA 56.

(7) The RA 56 signs the demand.

(8) The RA 56 sends the signed demand to the CA 57.

(9) The CA 57 issues a new certificate.

(10) The CA 56 publishes a new certificate in the LDAP 58 directory.

(11) The CA sends the newly issued certificate to the RA.

(12) The registration operator picks up the newly issued certificate and its distribution by e-mail is automatically provided.

(13) The client 53 installs the newly issued certificate to keys storage (software or SC).

Steps 1 and 3 of this procedure can be modified wherein the registration operator fills in the electronic demand for the certificate based on an ID (e.g. passport) and an e-mail address (offered to clients in a paper form, for exactness). This demand will be printed and consequently signed by the client.

2. Validation Process

The last step of each registration process is validation of the issued client certificate. In this step the accuracy of the certificate is checked, by checking whether the private key generated for the specific certificate fits the public key in the certificate. Validation of the certificate has functional significance (if the certificate is not exact, it is not applicable), not safety significance (in case of underplayed false certificate, the verification process marks it as failed or unreliable and as such it cannot be applicable either).

The validation process is a revision of certificate's utility. If the certificate validation is not executed, there is a threat that it will not be applicable. There is no safety risk that the certificate will be misused (falsified) unless the private key has been stolen or disclosed. Therefore it is advisable not to reduce the system's security in reliance on the validation process (e.g. by saving revocational passwords to special database). Based on the listed procedures providing solutions, it is advisable that the certificate not be suspended and the validity date rescheduled a few days earlier. During these days (which may be termed the “validity period”) the certificate will not be valid nor will it be on the revocational list of certificates. During the validity period the client runs the validation process to check the issued certificate. In case problems are found, the client may take action or otherwise inform the bank (e.g. through a call center or by canceling the certificate via Web) and the bank may ensure the revocation of the certificate. If during the validation period, the client does not report any problems with the issued certificate, the certificate automatically becomes valid after expiration of the period. Electronic signature of data is preferably utilized in the validation process. Using the applet, the client may download and sign the relevant data with his new private key. The data, digital signature, and newly issued certificate may be applet packed into a structured message and sent via a verification application (relying party). The verification application checks the electronic signature of data using the public key of the connected certificate, and 10 checks the contents and validity of the connected certificate (revision towards CRL or OCSP, depending on the final solution)

FIG. 10 is a flow chart 58 illustrating the steps for a validation process. The steps for a) revision of certificate validity towards CRL (LDAP) are indicated in the figure as follows:

(0a) Verification application 59 downloads CRL from the LDAP 63.

(1) Applet 60 receives the client's data for signature.

(2) Applet ensures the signing of the data and prepares a structured message to be sent.

(3) The message is sent to the verification application 59.

(4a) The verification application 59 revises the signature and verifies the validity of the connected certificate towards the CRL.

(7) The verification application 59 sends the response to the client 61.

Additionally, the steps for b) the revision of a certificate's validity via a Validity authority (OCSP responder) are indicated in the figure as follows:

(0b) The certificate's state is published.

(1) Applet 60 receives the client's data for signature.

(2) Applet ensures the signing of the data and prepares a structured message to be sent.

(3) The message is sent to the verification application 59.

(4b) The verification application 59 sends a demand for validation of the certificate.

(5b) The validation authority 62 (OCSP responder) processes the demand for validation.

(6b) The validation authority sends the response to the verification application 59.

(7) The verification application resends the response to the client.

3. Certificate and Keys' Renewal

Renewal of the certificate's validity by generating a new pair of keys basically means cancellation of the validity of the old certificate and issuance of a new certificate with new keys. Issuing the new certificate must be verified directly during a visit to the bank's registration place or by using the system's technology (with electronic signature for the demand of the certificate's renewal).

Various processes may provide for the renewal of keys for software and certificate utilizing the original certificate and keys. The security level of the newly issued certificate will be identical with the security level of the original certificate (i.e. it is not possible to renew keys on the BCC using a software certificate).

To renew certificates and keys, it is necessary to perform the following:

1. To generate new keys and make a request for a new certificate, the request being made by the client.

2. To find the connection between the old certificate and the request for the new certificate, verify the contents of the new request for the certificate, and further ensure the arrangement and pre-preparation of data (Registration BackEnd Server).

3. Issue a new certificate with immediate validity and suspend the old certificate.

4. Verify the newly issued certificate (see validation process).

To ensure these steps, the client will use a special application that will generate a pair of keys and will prepare the demand for a certificate and keys' renewal. The application will pack the demand into a structured message that will contain the request for issuing a certificate. The structured message will be signed by the old private key (the “old” certificate will be a part of the message). The RBE Server will be instrumental in the initial revision of the request for a certificate's renewal as well as in dispersing data and will pre-prepare data for the ARM module. The ARM module makes the request for the new certificate (to the RA) and suspends the old certificate's validity. After the processing is complete, the newly issued certificate will be distributed to the client via e-mail. The client is also informed about suspension of the old certificate's validity by an e-mail. The client installs a new certificate (this certificate is immediately valid). In the next step, the client verifies the functionality of the newly issued certificate (see Validation process). In case the new certificate is not functional, the client initiates the unsuspending of the old certificate and the new certificate will be suspended. If the new certificate is functional, the client can utilize it immediately. FIG. 11 is a flow diagram 64 illustrating the procedure for the renewal of keys and certificate, without the validation process. The procedural steps, numbered (1) through (18) in the figure are as follows:

(1) The bank's client 65 uses a special application to demand keys and certificate renewal.

(2) The application ensures generation of a new set of keys (Software or SC), and “packs” the demand for the certificate together with the old certificate to to a structured message signed by an old private key.

(3) The application sends the request for renewal to the RFE server 66.

(4) The RFE Server re-sends the request to the RBE Server 67.

(5) The RBE unpacks the structured message, verifies the, validity of the old certificate towards CRL (RBE can download CRL individually during later steps of the process).

(6) The RFE 66 pre-prepared data is sent for processing through the ARM and saves it in the ARM database 68.

(7) The ARM 69 takes over the pre-prepared data from the ARM database 68.

(8) The ARM processes the data, including the request for suspending the certificate's validity and demand for issuing a new certificate, and sends the data to the RA (or RA database 70).

(9) The RA signs the demand.

(10) The demands are sent from the RA to the CA 71.

(11) The CA processes the demands.

(12) The new certificates are published in the LDAP, and the old certificate is revoked in the CRL.

(13) The CA sends the newly issued certificate to the RA.

(14) The RA sends the output from demands processing to the ARM.

(15) The ARM prepares an e-mail for distribution of the new certificate and a notice about suspension of the old certificate and sends the messages to a MailGateway 73.

(16) The MailGateway re-sends the mail to the client

(17) The client downloads the newly issued certificate from the web address.

(18) The client installs the newly issued certificate to the keys storage (software or SC).

4. Extending Certificate's Validity/Change of Data in the Certificate

The process for extending a certificate's validity is similar to the process for effectuating a change of data in the certificate in terms of utilizing architecture. The client indicates in the client application that apart from extending certificate's validity, he request a change of data in the certificate. The process is almost identical to the process of keys' renewal. The only difference is that no new keys are generated and in the PKCS#10 demand, the old private key signs the old public key.

5. Suspending a Certificate's Validity

Different types of clients can request the suspension of a certificate's validity via a) web-pages of the bank by entering a pass phrase to suspend the certificate; b) a telephonic call to a call center whereby the client recites a pass phrase to an operator who will have the ability to suspend the certificate; and c) by a personal visit to the bank's branch office. A Pass phrase to suspend the certificate's validity will exist for each issued certificate. The same pass phrase may be used for suspending the certificate, revoking its validity, and unsuspending or reinstating the certificate.

5.1 Suspending of Validity through Web-Pages

The steps for suspending a certificate via a banks web page are as follows:

(1) The Client logs into the bank's web page and runs the applet for suspending a certificate.

(2) He fills in the necessary data (e.g. first name, surname, special client number and revocational pass phrase).

(3) The application prepares a PKCS#7 message for client, coded by a public key of the RBE Server containing a request for suspending and sends it to the RFE Server.

(4) The RFE Server resends the demand to the RBE Server.

(5) The RBE Server pre-prepares the demand to an acceptable format for the ARM (strong arm processor).

(6) The ARM takes over the demand, processes it and shifts it to further processing in the RA.

(7) The RA automatically signs the demand.

(8) The RA sends the signed demand to the CA.

(9) The CA suspends the certificate and issues a new CRL and writes it to the LDAP directory.

(10) The CA informs the RA about this.

(11) The ARM receives the message from the RA regarding successful suspending, and resends an e-mail to the user (via mail-gateway).

5.2 Suspending of Validity Telephonically or by Personal Visit of the Bank

In this case a registration operator (WebRAO operator in the branch office or RAO or CAO operator in the main office in case of fault) effectuates the suspension. The client provides the necessary data (first name, surname and special client number).

While the present invention has been described with regards to particular embodiments, it is recognized that additional variations of the present invention may be devised without departing from the inventive concept.

What is claimed is:

1. A method for conducting a commercial transaction comprising:
registering customers with a central unit, wherein each customer provides registration authentication information and at least one financial account to said central unit;
identifying a registered customer through said central unit by obtaining identifying authentication information from said customer and comparing said identifying authentication information with said registration authentication information for producing either a successful or failed identification;
upon a successful identification, issuing a temporary transaction code to said customer; and conducting a transaction with a merchant using said temporary transaction code.

2. The method of claim 1, further comprising issuing to each customer a money tag device by said central unit upon registration with said central unit, wherein said identifying authentication information can be sent to said central unit using said money tag device.

3. The method of claim 2, wherein said money tag device interfaces with a customer's computer.

4. The method of claim 2, wherein each money tag device issued to each of said customers has an associated unique money tag ID, wherein said identification authentication information from said customer comprises said unique money tag ID.

5. The method of claim 2, wherein said temporary transaction code is sent to the money tag device, and wherein said money tag device comprises a display screen for displaying said transaction code.

6. The method of claim 1, wherein said registration authentication information comprises a personal identification code, a biometric sample, or a combination thereof.

7. The method of claim 6, said personal identification code comprising a number, password, or alphanumeric combination.

8. The method of claim 1, further comprising registering merchants with said central unit wherein each of said merchants registers at least one merchant financial account.

9. The method of claim 8 wherein upon conducting said transaction between a customer and merchant, the customer's financial account is debited, and the merchant's financial account is credited.

10. The method of claim 1, further comprising issuing each of said customers a money tag device upon registration, each money tag device having a unique money tag ID, wherein
said registration authentication information comprises a personal identification code, a biometric sample, or a combination thereof, and wherein
identifying said customer comprises receiving from said customer, through said money tag device, said unique money tag ID, said personal identification code, said biometric sample, or a combination thereof.

11. The method of claim 1 wherein said temporary transaction code surrogates said customer's personal authentication information while conducting said transaction.

12. The method of claim 1, further comprising offering to said customer a proposed commercial transaction, comprising transaction information, said proposed commercial transaction being offered by a merchant.

13. The method of claim 12 wherein said transaction information comprises transaction price, identification of goods, identification of services, a merchant name, a date and time related to said transaction, a location associated with said transaction, an invoice number, or a combination thereof.

14. The method of claim 13 wherein said customer indicates acceptance of said proposed commercial transaction by sending said temporary transaction code to said merchant.

15. The method of claim 14 further comprising transmitting said transaction information and said temporary transaction code, wherein said central unit verifies said temporary code.

16. The method of claim 15, wherein upon verification of said temporary transaction code, and upon verification of sufficient funds, a financial account of said customer is debited, and a financial account of said merchant is credited.

17. The method of claim 1 wherein said customer is remote from said merchant and communicates with said merchant using a computer network.

18. The method of claim 17 wherein said computer network is the Internet.

19. The method of claim 1, wherein said registration authentication information comprises a personal identification code and a biometric sample, and wherein said personal identification code is changed whenever said customer's biometric sample is determined to have been stolen.

20. The method of claim 19 wherein said biometric sample comprises a fingerprint, hand print, voice print, retinal sample, handwriting sample, or a combination thereof.

21. The method of claim 1 wherein all electronic communication to and from the central unit is encrypted.

22. The method of claim 1 further comprising generating a database which includes identification information of individuals who have been determined as having attempted or committed fraud, wherein said individuals are denied registration.

23. The method of claim 1 wherein said temporary code substitutes said customer's authentication information such that said transaction is completed without the need to provide customer's personal information to said merchant, or transfer said information across a network.

24. The method of claim 1, wherein authorization and money transfer for completing the transaction is carried out by an external credit/debit network system system.

25. The method of claim 1, wherein a message indicating the success or failure of any step in the transaction is presented to said merchant and said customer.

26. A method of conducting an online transaction comprising:
receiving authentication information from a customer comprising a private code known to the customer, identification information associated with the customer and related to a token issued to the customer, and a biometric sample from said customer;
verifying said authentication information; and
providing a temporary code to said customer, said code to be used by said customer for completing a single transaction with an online merchant.

27. A method of increasing the security of online commercial transactions between a merchant and customer comprising:
storing authentication information related to the customer;
receiving authentication information through a token issued to the customer; wherein
said authentication information is stored at a location which is operationally isolated from both the merchant and customer.

28. A method of increasing the security of online commercial transactions comprising:
providing system comprising a central unit which generates a temporary transaction code for use in conducting a transaction between a merchant and a customer, said system comprising secure transaction means;
requiring registration by said merchant and said customer as a precondition for using said system;
generating a database comprising identification information concerning individuals determined to attempted or to have committed fraud; and
denying said individual's registration with said system.

29. A method for authentication of commercial transactions between a customer and a merchant using a computer system, the method comprising the steps of:
a. a customer registration step, wherein the customer is given a money tag device by a central unit, said money tag having a unique money tag ID, and the customer further registers with said central unit a personal identification code, at least one registration biometric sample, and at least one customer financial account;
b. a merchant registration step, wherein the merchant registers with said central unit at least one merchant financial account;
c. a customer identification step, wherein the customer sends personal authentication information comprising said personal identification code, at least one biometric sample obtained from the customer's person using said money tag, and said money tag ID to said central unit for producing either a successful or failed identification of the customer, wherein said central unit generates and sends to said money tag a private code that surrogates customer's personal authentication information during processing of the transaction;
d. a proposal step, wherein the merchant offers a proposed commercial transaction to the customer, the proposed commercial transaction comprising transaction data including 1s price information;
e. an acceptance step, wherein the customer signals acceptance of the merchant's proposed commercial transaction and customer's money tag adds to said proposed commercial transaction said private code;
f. a transmission step, wherein said transaction data including said private code is forwarded from the merchant to said central unit for verification of said private code; and
g. a payment step, wherein upon determination of sufficient resources, a financial account of the customer is debited and a financial account of the merchant is credited, wherein a commercial transaction is conducted with the customer having to use said money tag.

30. A portable device for use in conducting commercial transactions comprising:
at least one biometric scanner; and
a display screen, wherein said device is capable of interfacing with a customer's computer for receiving and transmitting information related to a transaction, and wherein said device displays information messages on said display, such that unencrypted private information is not revealed to said customer's computer.

31. The device of claim 30 wherein said portable device is used in a commercial transaction method wherein a customer is given a private code for use in said transaction, said private code surrogating customer's private information.

32. The device of claim 31 wherein said unencrypted biometric data and an unencrypted private code are never revealed to said customer's computer.

33. The device of claim 31 wherein said private code is transmitted to said customer by a central unit which authenticates said customer, and wherein the device sends encrypted authentication information to said central unit.

34. The device of claim 31 wherein said device is capable of receiving a personal identification code from said customer's computer, and wherein said personal identification code and a biometric received from said customer are transmitted to a central unit for authenticating said customer.

35. The device of claim 34, wherein said personal identification code, said biometric, and said private code are stored on the device in RAM.

36. The device of claim 30, wherein said customer's computer communicates with the device by sending commands and receiving results over a serial port or standard infrared IrDA port.

37. The device of claim 30 wherein the device receives and transmits information to a central unit, wherein said central unit attempts to authenticate said customer, wherein the device has a unique encryption key pair, known only to the device and said central unit.

38. The device of claim 37 wherein the device has a unique hardware identification code which is registered with said central unit, and which is transmitted to said central unit in attempting to authenticate said user.

39. The device of claim 30 further comprising:
a ROM element which stores noncritical commonly available code.

40. A device for use in conducting a commercial transaction comprising:
at least one biometric input element comprising a biometric encoding algorithm;
a display element which displays a temporary transaction code which surrogates a customers private information and is used in the transaction; and
a unique identification code associated with said device, wherein
said biometric encoding algorithm and said unique identification code are stored on the device in flash ROM, and wherein
said biometric, and said temporary transaction code are stored on the device in RAM.

41. A host or central unit which facilitates online commercial transactions between a merchant and customer comprising:
a customer database, said customer database comprising registration authentication information which is received from each customer upon registering said customer with the central unit, said registration authentication information including biometric data;
a receiving element which receives identifying authentication information from said customer, said identifying authentication information being compared to said registration authentication information for producing either a failed or successful authentication of said customer; and
an element which generates a transaction code which surrogates said the customer's private information, and transmits said transaction code to said customer, wherein said transaction code is used by said customer for conducting a single transaction with said merchant.

42. The central unit of claim 41 wherein said customer database further includes at least one customer financial account for each registered customer.

43. The central unit of claim 41, further comprising a merchant database which includes at least one financial account for each registered merchant.

44. The central unit of claim 41 further comprising a defrauders database which has a list of known system defrauders, wherein listed defrauders are denied use of said central unit for conducting commercial transactions.

45. The central unit of claim 41 further comprising a transaction database which records system transactions.

46. A method for conducting a commercial transaction comprising:
registering an entity comprising a customer, merchant, or a combination thereof with a central unit;
issuing a certificate upon said registration, said certificate being associated with at least one key; and
conducting said transaction through said central unit, using said key for facilitating the security of said transaction, said entity being a party to said transaction.

47. The method of claim 46, further comprising filling in a demand for said certificate and generating said key through a computer operated by said entity, said central unit, an outside agent, or a combination thereof.

48. The method of claim 46, further comprising verifying the identity of said entity upon said registering of said entity.

49. The method of claim 46, further comprising checking the validity of the issued certificate by verifying that a private key generated for the certificate fits a public key in the certificate.

50. The method of claim 46 wherein the issued certificate may be renewed by generating at least one new key to replace an original key.

51. The method of claim 46 wherein the data in the issued certificate may be subsequently changed without replacing said key.

52. The method of claim 46 wherein the issued certificate may be suspended.

53. The method of claim 46 wherein a plurality of commercial transaction are conducted by a plurality of customers and merchants, further comprising checking for unusual or inconsistent transaction patterns to detect potential fraud.
